(19) United States
(12) Patent Application Publication
(10) Pub. No.: US 2012/0113605 A1
(43) Pub. Date: May 10, 2012

(54) Wireless Modem

(75) Inventors: Bin Zhang, Shenzhen (CN); Menglong Zhao, Shenzhen (CN); Yongqiang Xue, Xian (CN); Jianjun Xiao, Shenzhen (CN)

(73) Assignee: Huawei Device Co., LTD, Shenzhen (CN)

(21) Appl. No.: 13/289,611

(22) Filed: Nov. 4, 2011

(30) Foreign Application Priority Data
Nov. 5, 2010 (CN) 201010537377.2

(51) Int. Cl. H05K 5/02

(52) U.S. Cl. 361/752

(57) ABSTRACT

A wireless modem is disclosed in the embodiments of the present invention. The wireless modem includes an interface, a supporting portion, and a casing. A circuit board is disposed inside the casing, and an antenna is disposed on the circuit board. The interface is connected to the supporting portion in a rotating manner through a first rotating shaft assembly, and a rotation direction of the interface relative to the supporting portion is a first direction. The casing is connected to the supporting portion in a rotating manner through a second rotating shaft assembly, and a rotation direction of the casing relative to the supporting portion is a second direction.

This application claims priority to Chinese Patent Application 201010537377.2, which was filed Nov. 5, 2010 and is incorporated herein by reference.

### TECHNICAL FIELD

The present invention relates to the field of communications technologies, and in particular, to a wireless modem.

### BACKGROUND

In the conventional art, with the gradual development of 3rd-generation (3G) mobile telecommunication services, a wireless modem is used more and more commonly. In the market, a schematic structural diagram of a mostly common wireless modem may be shown in FIG. 1. The wireless modem includes an interface 101 and a main body 102, where the interface 101 is configured to establish a connection between the main body 102 and a computer, and the main body 102 may include a casing and a circuit board disposed inside the casing. An antenna may be disposed on the circuit board inside the casing, or may be disposed outside the casing, and is connected to the circuit board inside the casing.

In the implementation of the present invention, the inventors find that the conventional art has at least the following problems.

A direct-insert wireless modem has rather strict requirements on space and position, and in the case of a cramped space, many inline wireless modem cannot be used.

Meanwhile, in the case that the antenna is built in the circuit board inside the casing, the inline wireless modem cannot adjust a receiving direction and an angle of the antenna.

### SUMMARY OF THE INVENTION

Embodiments of the present invention provides a wireless modem, so as to solve problems that a wireless modem cannot be used in a cramped space, and a receiving direction and an angle of an antenna cannot be adjusted in the conventional art.

A wireless modem is provided in an embodiment of the present invention includes an interface, a supporting portion, and a casing, where a circuit board is disposed inside the casing and an antenna is disposed on the circuit board.

The interface is connected to the supporting portion in a rotating manner through a first rotating shaft assembly, and a rotation direction of the interface relative to the supporting portion is a first direction.

The casing is connected to the supporting portion in a rotating manner through a second rotating shaft assembly, and a rotation direction of the casing relative to the supporting portion is a second direction.

With the wireless modem provided in the embodiment of the present invention, by connecting the interface with the casing through the supporting portion, the interface may rotate relatively to the supporting portion in the first direction through the first rotating shaft assembly, and the casing may rotate relatively to the supporting portion in the second direction through the second rotating shaft assembly, so that the casing may rotate relatively to the interface in two dimensions, therefore, the problem that the wireless modem cannot be used due to a cramped space is effectively solved; moreover, a built-in antenna may receive wireless signals from different angles with the rotation of the casing, and a signal receiving effect is good.

### BRIEF DESCRIPTION OF THE DRAWINGS

To describe the technical solutions in the embodiments of the present invention or in the conventional art more clearly, the accompanying drawings required for describing the embodiments or the conventional art are introduced briefly in the following. Apparently, the accompanying drawings in the following descriptions are merely some embodiments of the present invention, and persons of ordinary skill in the art may also obtain other drawings according to these accompanying drawings without creative efforts.

FIG. 1 is a schematic structural diagram of a wireless modem according to the conventional art;

FIG. 2 is a schematic structural diagram of a wireless modem according to an embodiment of the present invention;

FIG. 3 is a schematic structural diagram of a first rotating shaft assembly according to an embodiment of the present invention;

FIG. 4 is a schematic exploded diagram of FIG. 3;

FIG. 5 is another schematic structural diagram of a first rotating shaft assembly according to an embodiment of the present invention;

FIG. 6 is a schematic structural diagram showing cooperation of a spacing gasket with a sleeve and an elastic member according to an embodiment of the present invention;

FIG. 7 is another schematic structural diagram of a first rotating shaft assembly according to an embodiment of the present invention;

FIG. 8 is a schematic exploded diagram of FIG. 7;

FIG. 9 is a schematic exploded diagram of FIG. 7 seen from an direction opposite to that of FIG. 8;

FIG. 10 is a schematic structural diagram showing a connection between an interface and a supporting portion according to an embodiment of the present invention;

FIG. 11 is a schematic exploded diagram of FIG. 10;

FIG. 12 is a schematic structural diagram of a wireless modem according to an embodiment of the present invention;

FIG. 13 is a schematic structural diagram showing cooperation of a decoration member with an interface according to an embodiment of the present invention;

FIG. 14 is a schematic diagram showing a connection between a upper cover and a lower cover according to an embodiment of the present invention;

FIG. 15 is a schematic diagram showing a connection between a first rotating shaft assembly with an interface and a supporting portion according to an embodiment of the present invention;

FIG. 16 is a schematic structural diagram of a second rotating shaft assembly according to an embodiment of the present invention; and

FIG. 17 is a schematic exploded diagram of FIG. 16.

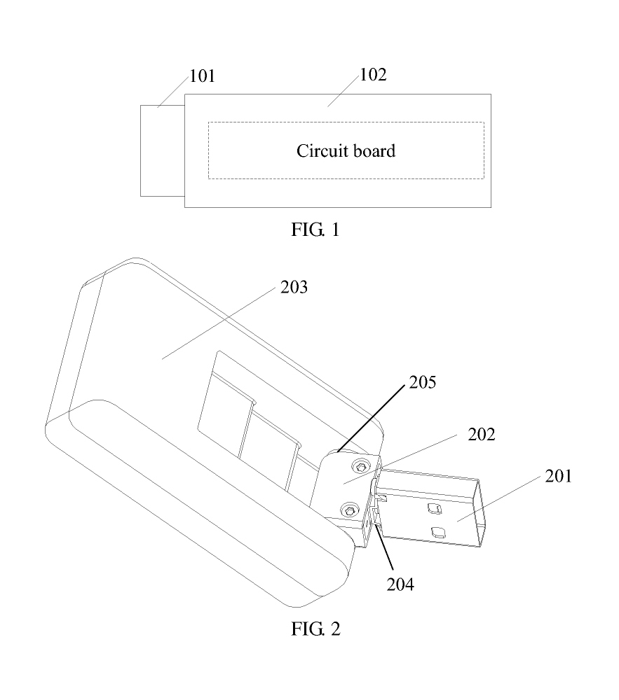

### DETAILED DESCRIPTION OF ILLUSTRATIVE EMBODIMENTS

In order to make the objectives, the technical solutions and the advantages of the embodiments of the present invention more clearly, the technical solutions in the embodiments of the present invention are clearly and completely described in the following with reference to the accompanying drawings in the embodiments of the present invention. Obviously, the embodiments to be described are only a part rather than all of the embodiments of the present invention. Based on the embodiments of the present invention, other embodiments obtained by persons skilled in the art without creative efforts shall all fall within the protection scope of the present invention.

FIG. 2 is a schematic structural diagram of a wireless modem according to an embodiment of the present invention. As shown in FIG. 2, the wireless modem includes an interface 201, a supporting portion 202, and a casing 203. A circuit board is disposed inside the casing 203, and is configured to complete a corresponding modem function. An antenna is disposed on the circuit board, and is configured to receive or transmit wireless signals. The interface 201 is connected to the supporting portion 202 in a rotating manner through a first rotating shaft assembly 204, and a rotation direction of the interface 201 relative to the supporting portion 202 is a first direction. The casing 203 is connected to the supporting portion 202 in a rotating manner through a second rotating shaft assembly 205, and a rotation direction of the casing 203 relative to the supporting portion 202 is a second direction. The interface 201 may be a Universal Serial Bus (USB) interface or a Wireless Fidelity (WIFI) interface.

With the wireless modem according to this embodiment of the present invention, by connecting the interface with the casing through the supporting portion, the interface may rotate relatively to the supporting portion in the first direction through the first rotating shaft assembly, and the casing may rotate relatively to the supporting portion in the second direction through the second rotating shaft assembly, so that the casing may rotate relatively to the interface in two directions or even on two planes; therefore, a problem that the wireless modem cannot be used due to cramped space is effectively solved, moreover, a built-in antenna may receive wireless signals from different angles with the rotation of the casing, and a signal receiving effect is good.

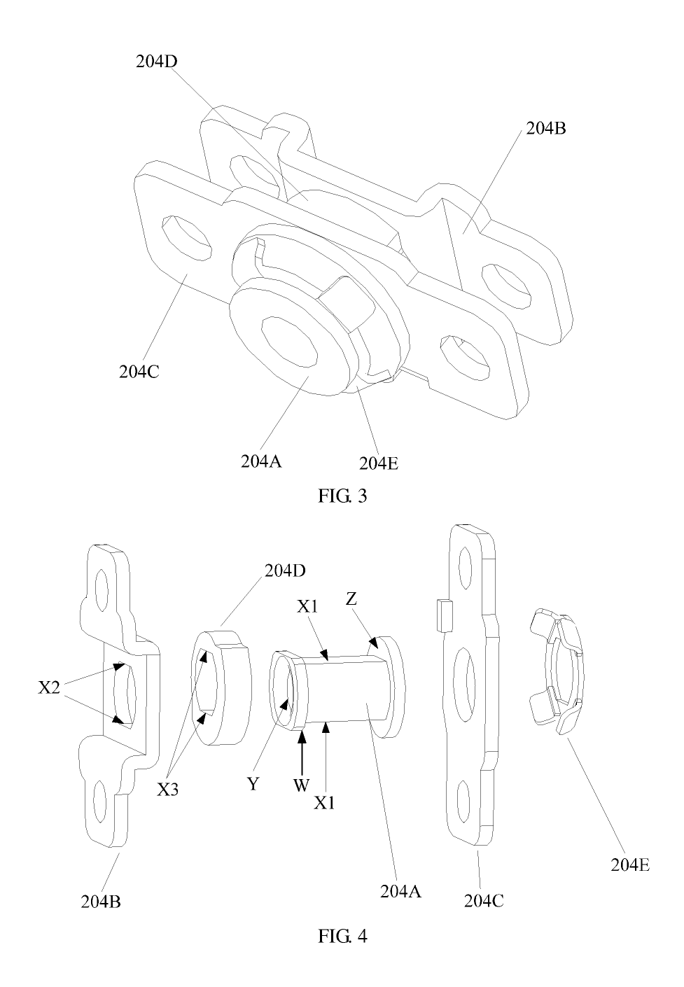

A schematic structural diagram of the first rotating shaft assembly may be shown in FIG. 3, and FIG. 4 is a schematic exploded diagram of FIG. 3. The first rotating shaft assembly includes a sleeve 204A, a fixed bracket 204B, a movable bracket 204C, a spacing ring 204D, and an elastic member 204E.

Specifically, a locating surface X1 is disposed on an outer surface of the sleeve 204A, and the number of the locating surfaces X1 may be one, two, or more, and in this embodiment, two locating surfaces X1 are taken as an example for description. The sleeve 204A has a through path (or hole) Y in the middle of the sleeve 204A, so as to ensure that a wire cable connecting the interface 201 and the circuit board inside the casing 203 passes through the through path (or hole) Y to enter the supporting portion 202.

The fixed bracket 204B is sleeved on the sleeve 204A, one side of the fixed bracket 204B may be backstopped and fixed by an end surface W on one side of the sleeve 204A, and the other side may be backstopped and fixed by the spacing ring 204D. A locating surface X2 in cooperation with the locating surface X1 on the outer surface of the sleeve 204A is disposed on an inner surface of the fixed bracket 204B.

The movable bracket 204C is sleeved on the sleeve 204A, and no locating surface is disposed on an inner surface of the movable bracket 204C, so that the movable bracket 204C may rotate around the sleeve 204A freely.

The spacing ring 204D is sleeved on the sleeve 204A, and is located between the fixed bracket 204B and the movable bracket 204C. A locating surface X3 in cooperation with the locating surface X1 on the outer surface of the sleeve 204A is disposed on an inner surface of the spacing ring 204D. The locating surface X3 disposed on the inner surface of the spacing ring 204D is configured to restrict the position of the fixed bracket 204B.

The elastic member 204E is sleeved on the sleeve 204A, and is located between the movable bracket 204C and an end surface Z on the other side of the sleeve 204A. In this embodiment, a resilient plate is taken as an example to describe the elastic member 204E, and definitely, the elastic member 204E may also be a spring.

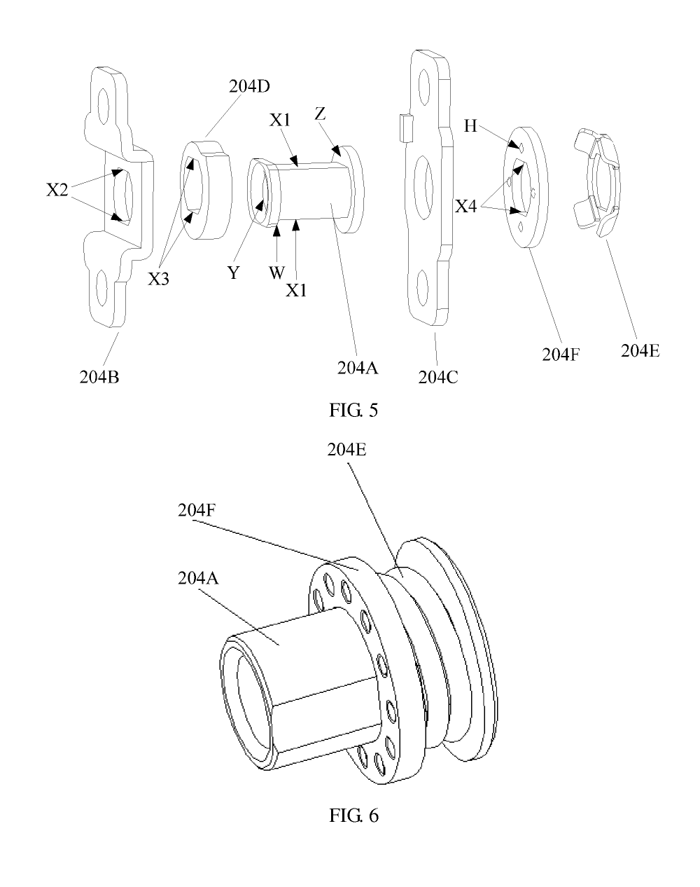

FIG. 5 is another schematic structural diagram of a first rotating shaft assembly according to an embodiment of the present invention. Compared with the structure of the first rotating shaft assembly as shown in FIG. 4, the first rotating shaft assembly further includes a spacing gasket 204F. The spacing gasket 204F is sleeved on the sleeve 204A, and is located between the movable bracket 204C and the elastic member 204E. Moreover, a locating surface X4 in cooperation with the locating surface X1 on the outer surface of the sleeve 204A is disposed on an inner surface of the spacing gasket 204F. A concave point H may be disposed on the spacing gasket 204F; and a bump (not shown in the FIG.) used in cooperation with the concave point H is disposed on a corresponding position of the movable bracket 204C. The spacing gasket 204F is configured to locate the position of the movable bracket 204C through the cooperation of the concave point H on the spacing gasket 204F and the bump on the movable bracket 204C during the rotation of the movable bracket 204C around the sleeve 204A. Definitely, in other embodiments, a bump may be disposed on the spacing gasket 204F; and a concave point may be disposed on a corresponding position of the movable bracket 204C. The position of the movable bracket 204C is located in the rotation around the sleeve 204A through the cooperation of the bump with the concave point.

The bumps or the concave points may be evenly disposed on the spacing gasket 204F and the movable bracket 204C, and the number of the bumps and the concave points is not limited in this embodiment, and the number of the bumps may be less than or equal to the number of the concave points. When the elastic member 204E is a spring, a schematic structural diagram showing cooperation of the spacing gasket 204F with the sleeve 204A and the elastic member 204E may be shown in FIG. 6.

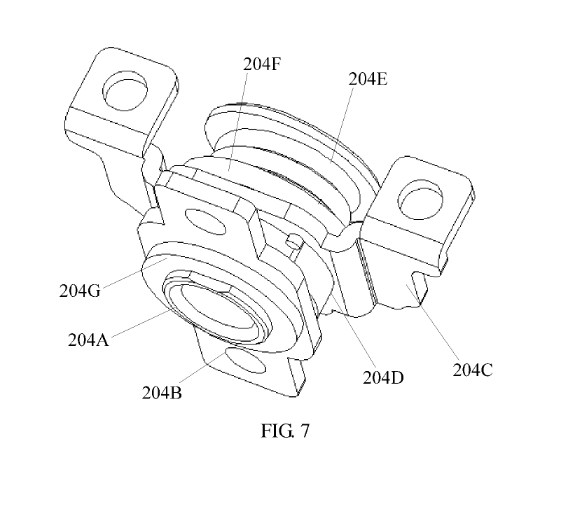

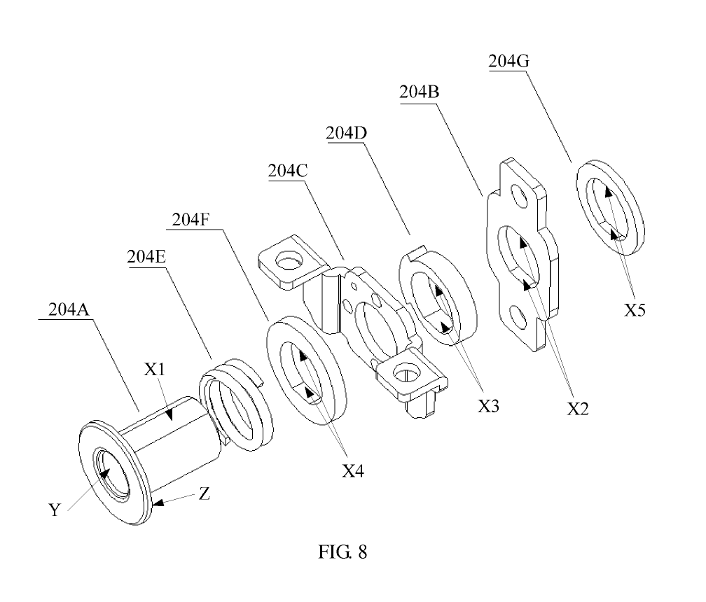

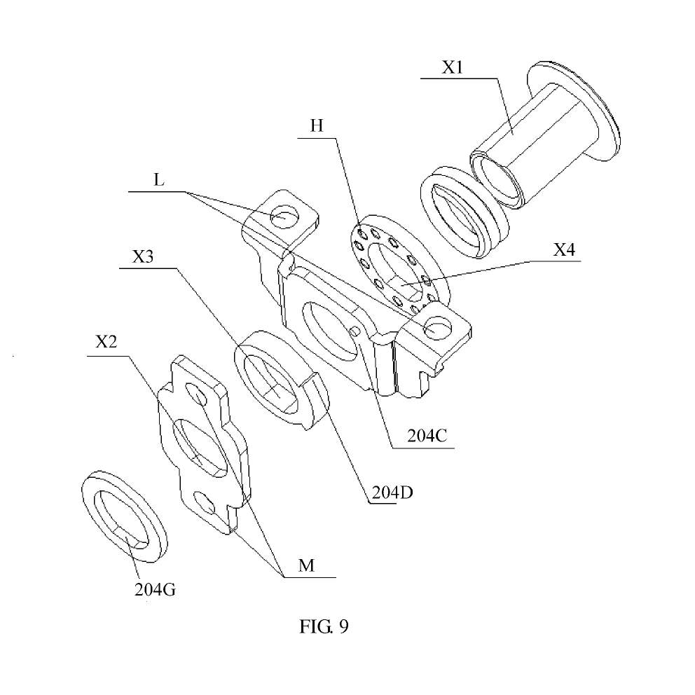

FIG. 7 is a schematic structural diagram of a first rotating shaft assembly according to an embodiment of the present invention, FIG. 8 is a schematic exploded diagram of FIG. 7, and FIG. 9 is a schematic exploded diagram of FIG. 7 seen from an direction opposite to that of FIG. 8. The first rotating shaft assembly includes a sleeve 204A, a fixed bracket 204B, a movable bracket 204C, a spacing ring 204D, an elastic member 204E, a spacing gasket 204F, and a locking gasket 204G. In this embodiment, a spring is taken as an example to describe the elastic member 204E.

A locating surface X1 is disposed on an outer surface of the sleeve 204A, and the number of the locating surfaces X1 may be one, two, or more, and in this embodiment, two locating surfaces X1 are taken as an example for description. The sleeve 204A has a through path (or hole) Y in the middle of the sleeve 204A, so as to ensure that a wire cable connecting the interface 201 and the circuit board inside the casing 203 passes through the through path (or hole) Y to enter the supporting portion 202.

The fixed bracket 204B is sleeved on the sleeve 204A, one side of the fixed bracket 204B may be backstopped and fixed by the locking gasket 204G, and the other side may be backstopped and fixed by the spacing ring 204D. A locating surface X2 in cooperation with the locating surface X1 on the outer surface of the sleeve 204A is disposed on an inner surface of the fixed bracket 204B.

The movable bracket 204C is sleeved on the sleeve 204A, and no locating surface is disposed on an inner surface of the movable bracket 204C, so that the movable bracket 204C may rotate around the sleeve 204A freely.

The spacing ring 204D is sleeved on the sleeve 204A, and is located between the fixed bracket 204B and the movable bracket 204C. A locating surface X3 in cooperation with the locating surface X1 on the outer surface of the sleeve 204A is disposed on an inner surface of the spacing ring 204D. The locating surface X3 disposed on the inner surface of the spacing ring 204D is configured to restrict the position of the fixed bracket 204B.

The elastic part 204E is sleeved on the sleeve 204A, and is located between the movable bracket 204C and an end surface Z on the other side of the sleeve 204A.

The spacing gasket 204F is sleeved on the sleeve 204A, and is located between the movable bracket 204C and the elastic member 204E. Moreover, a locating surface X4 in cooperation with the locating surface X1 on the outer surface of the sleeve 204A is disposed on an inner surface of the spacing gasket 204F. A concave point H may be disposed on the spacing gasket 204F; and a bump (not shown in the FIG.) used in cooperation with the concave point H is disposed on a corresponding position of the movable bracket 204C. The spacing gasket 204F is configured to locate the position of the movable bracket 204C through the cooperation of the concave point H on the spacing gasket 204F and the bump on the movable bracket 204C during the rotation of the movable bracket 204C around the sleeve 204A. Definitely, in other embodiments, a bump may be disposed on the spacing gasket 204F, and a concave point may be disposed on a corresponding position of the movable bracket 204C. The position of the movable bracket 204C is located in the rotation around the sleeve 204A through the cooperation of the bump with the concave point.

The bumps or the concave points may be evenly disposed on the spacing gasket 204F and the movable bracket 204C, and the number of the bumps and the concave points is not limited in this embodiment, and the number of the bumps may be less than or equal to the number of the concave points.

The locking gasket 204G is sleeved on the sleeve 204A, and is located between the other end of the sleeve 204A and the fixed bracket 204B, and the locking gasket 204G is configured to fix the fixed bracket 204B on the sleeve 204A.

Meanwhile, it should be noted that, a connection hole L of the movable bracket 204C is configured to establish a connection between the interface 201 and the first rotating shaft assembly 204. The position of the connection hole L in this embodiment is different from that in the preceding embodiment, and the different position of the connection hole L may enable a connection manner between the interface 201 and the first rotating shaft assembly 204 to be different. In the same way, a connection hole M of the fixed bracket 204B is configured to establish a connection between the first rotating shaft assembly 204 and the supporting portion 202.

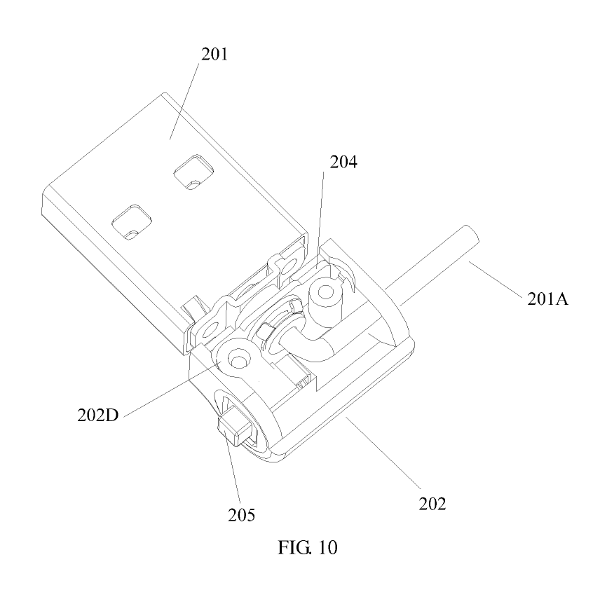

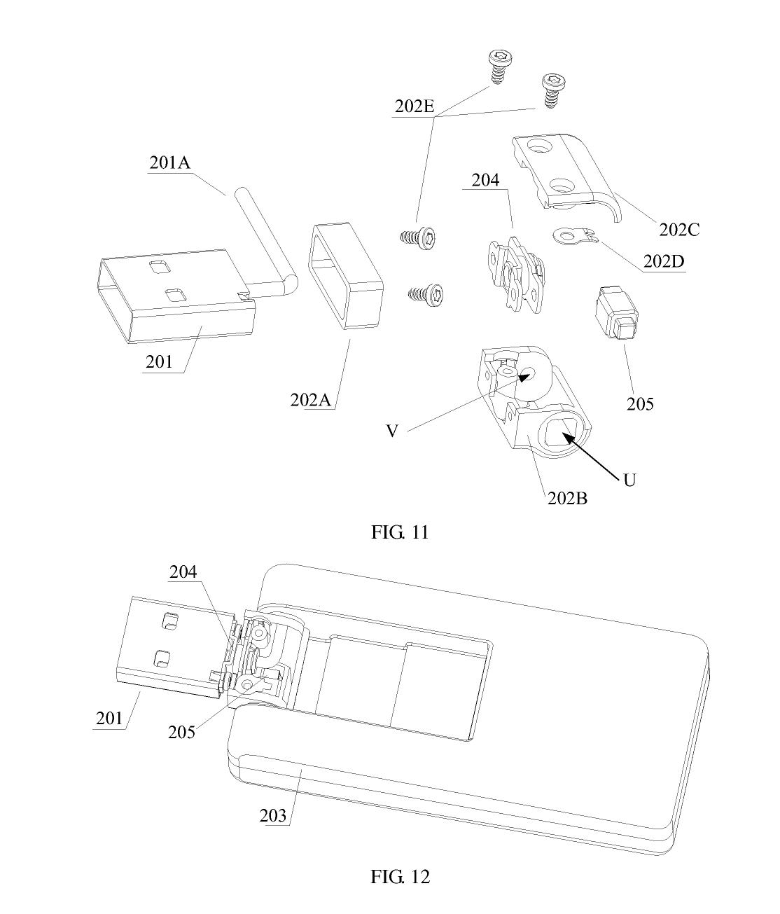

FIG. 10 is a schematic structural diagram showing a connection between the interface 201 and the supporting portion 202, FIG. 11 is a schematic exploded diagram of FIG. 10, and FIG. 12 is a schematic structural diagram of a wireless modem according to an embodiment of the present invention. The supporting portion 202 may include the following parts: a decoration member 202A (may be selectively included in the supporting portion 202), a lower cover 202B, an upper cover 202C, a grounding resilient plate 202D, and a screw 202E.

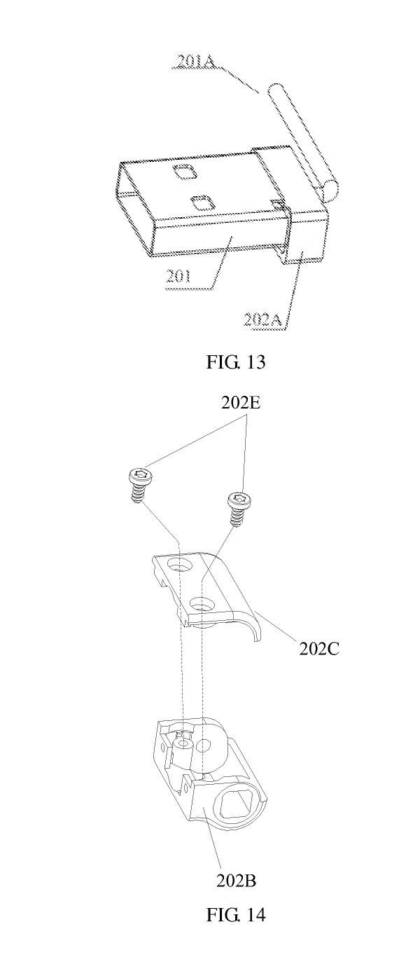

Specifically, the decoration member 202A may be sleeved at an end of the interface 201, and is configured to achieve perfect cooperation of the supporting portion 202 with the interface 201. FIG. 13 is a schematic structural diagram showing cooperation of the decoration member 202A with the interface 201.

A wire cable 201A used for connecting the interface 201 and the circuit board inside the casing 203 passes through the decoration member 202A and the through path Y of the first rotating shaft assembly 204, and enters the supporting portion 202.

According to a schematic diagram of a connection as shown in FIG. 14, the lower cover 202B and the upper cover 202C are fastened with each other through the screw 202E, and a dotted line in FIG. 14 represents a connection path of the screw 202E. It can be understood that, in other embodiments, the lower cover 202B and the upper cover 202C may be fastened with each other in other manners such as bonding and welding.

The fastened lower cover 202B and the fastened upper cover 202C form a cavity, and the first rotating shaft assembly 204, the second rotating shaft assembly 205, and the grounding resilient plate 202D are fastened in the cavity.

A hole V is disposed on the lower cover 202B, so that the wire cable 201A may further penetrate out of the supporting portion 202 through the hole V after entering the supporting portion 202 through the through path (or hole) Y of the first rotating shaft assembly 204. Accordingly, a hole also needs to be disposed on a corresponding position of the casing 203 in cooperation with the hole V of the supporting portion 202, so that the wire cable 201A can penetrate into the casing 203, so as to establish a connection with the circuit board inside the casing 203.

The lower cover 202B has a hole U on the other side opposite to one side where the hole V is located, the hole U is configured to accommodate the second rotating shaft assembly 205; furthermore, a shape of the hole U matches a shape of an outer surface of the second rotating shaft assembly 205. One part of the second rotating shaft assembly 205 passes through the hole U and is located in the supporting portion 202, and the other part is connected to a corresponding position of the casing 203.

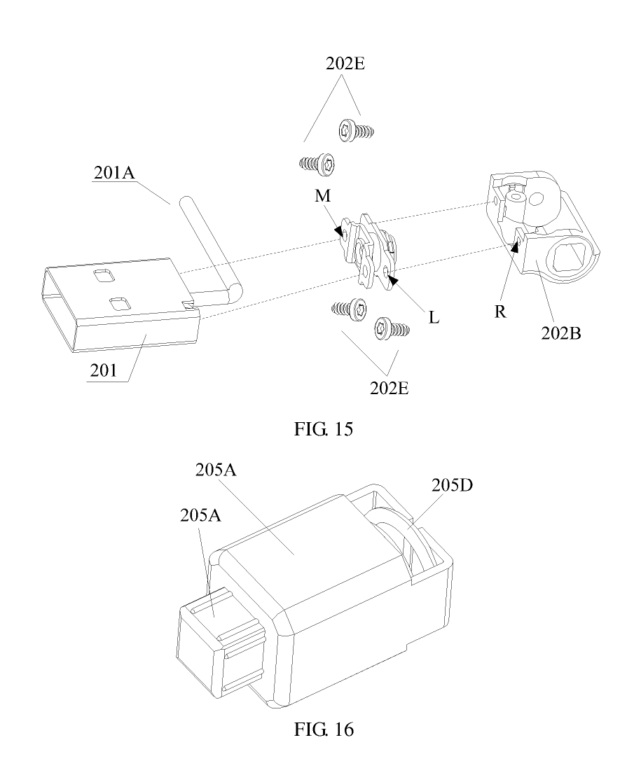

According to a schematic diagram of a connection as shown in FIG. 15, the hole M on the fixed bracket 204B in the first rotating shaft assembly 204 is connected with a threaded hole at the end of the interface 201 through the screw 202E, so that a connection is established between the first rotating shaft assembly 204 and the interface 201; and the hole L on the movable bracket 204C in the first rotating shaft assembly 204 is connected with a hole R on the lower cover 202B of the supporting portion 202 through the screw 202E, so that a connection is established between the first rotating shaft assembly 204 and the supporting portion 202. In this way, through the first rotating shaft assembly 204, a connection is established between the interface 201 and the supporting portion 202; meanwhile, with the first rotating shaft assembly 204, the interface 201 may rotate relatively to the supporting portion 202 in the first direction.

The grounding resilient plate 202D contacts the first rotating shaft assembly 204 and the second rotating shaft assembly 205 respectively, the first rotating shaft assembly 204 is electrically connected to a metal shield layer inside the interface 201, the second rotating shaft assembly 205 is electrically connected to the circuit board inside the casing 203, so that the ground resilient plate 202D is configured to ground the circuit board inside the casing 203. Definitely, the first rotating shaft assembly 204 may be connected with the second rotating shaft assembly 205 by using any type of conductor.

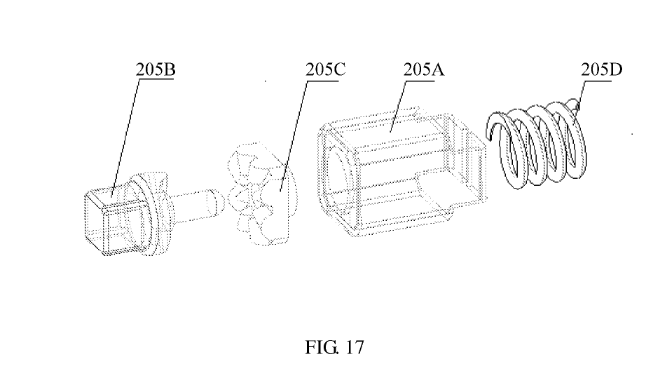

FIG. 16 is a schematic structural diagram of a second rotating shaft assembly according to an embodiment of the present invention, and FIG. 17 is a schematic exploded diagram of FIG. 16. With reference to FIG. 16 and FIG. 17, the second rotating shaft assembly includes a rotating shaft covering 205A, a first cam 205B, a second cam 205C, and an elastic member 205D. The elastic member 205D may be a spring or a resilient plate.

Specifically, two ends of the first cam 205B are a fixed end and a connection rod respectively. The fixed end is disposed outside the rotating shaft covering 205A, and the second cam 205C and the elastic member 205D are sleeved on the connection rod. Cams between the first cam 205B and the second cam 205C may be used in cooperation, so as to locate the position of the first cam 205B in rotation. The hole U on the supporting portion 202 is connected to the rotating shaft covering 205A, and the casing 203 is connected to the fixed end of the first cam 205B. In the rotation of the casing 203 relative to the supporting portion 202, the rotation of the casing 203 drives the fixed end of the first cam 205B to rotate, and the second cam 205C implements rotation locating for the first cam 205B. The elastic member 205D provides an elastic force for the rotation of the first cam 205B.

With the wireless modem provided in this embodiment of the present invention, by connecting the interface with the casing through the supporting portion, the interface may rotate relatively to the supporting portion in the first direction through the first rotating shaft assembly, and the casing may rotate relatively to the supporting portion in the second direction through the second rotating shaft assembly, so that the casing may rotate relatively to the interface in two directions or even on two planes; therefore, a problem that the wireless modem cannot be used due to a cramped space is effectively solved, moreover, a built-in antenna may receive wireless signals from different angles with the rotation of the casing, and a signal receiving effect is good.

Finally, it should be noted that the preceding embodiments are merely used for describing the technical solutions of the present invention, but not intended to limit the present invention. It should be understood by persons of ordinary skill in the art that although the present invention is described in detail with reference to the embodiments, modifications may also be made to the technical solutions described in the embodiments, or equivalent replacements may also be made to some technical features in the technical solutions; however, these modifications or replacements do not make the essence of the corresponding technical solution depart from the spirit and scope of the technical solutions in the embodiments of the present invention.

1. A wireless modem, comprising:
an interface,
a supporting portion,
a casing,
a circuit board disposed inside the casing,
an antenna disposed on the circuit board,
a first rotating shaft assembly, wherein the interface is connected to the supporting portion in a rotating manner through the first rotating shaft assembly, and a rotation direction of the interface relative to the supporting portion is a first direction; and
a second rotating shaft assembly, wherein the casing is connected to the supporting portion in a rotating manner through the second rotating shaft assembly, and a rotation direction of the casing relative to the supporting portion is a second direction.

2. The wireless modem according to claim 1, wherein the first rotating shaft assembly comprises a sleeve, a fixed bracket, a movable bracket, a spacing ring, and an elastic member;
wherein a locating surface is disposed on an outer surface of the sleeve;
wherein the fixed bracket is sleeved on the sleeve, and a locating surface in cooperation with the locating surface on the outer surface of the sleeve is disposed on an inner surface of the fixed bracket;
wherein the movable bracket is sleeved on the sleeve, and the movable bracket rotates around the sleeve;
wherein the spacing ring is sleeved on the sleeve and is located between the fixed bracket and the movable bracket, a locating surface in cooperation with the locating surface on the outer surface of the sleeve is disposed on an inner surface of the spacing ring, and the locating surface disposed on the inner surface of the spacing ring is configured to restrict the position of the fixed bracket; and
wherein the elastic member is sleeved on the sleeve, and is located between the movable bracket and an end surface on the other side of the sleeve.

3. The wireless modem according to claim 2, wherein the first rotating shaft assembly further comprises a spacing gasket;
wherein the spacing gasket is sleeved on the sleeve and is located between the movable bracket and the elastic member, and a locating surface in cooperation with the locating surface on the outer surface of the sleeve is disposed on an inner surface of the spacing gasket;
wherein a bump is disposed on the spacing gasket, and a concave point used in cooperation with the bump is disposed on a corresponding position of the movable bracket; or a concave point is disposed on the spacing gasket, and a bump used in cooperation with the concave point is disposed on a corresponding position of the movable bracket; and
wherein the spacing gasket is configured to locate the position of the movable bracket through the cooperation of the bump with the concave point during the rotation of the movable bracket around the sleeve.

4. The wireless modem according to claim 3, wherein the bumps or the concave points are evenly distributed on a circumference of the spacing gasket.

5. The wireless modem according to claim 2, wherein the fixed bracket is fixed on the sleeve through the other end surface of the sleeve; or
the first rotating shaft assembly further comprises a locking gasket and the locking gasket is sleeved on the sleeve and is located between the end surface on the other side of the sleeve and the fixed bracket, and the locking gasket is configured to fix the fixed bracket on the sleeve.

6. The wireless modem according to claim 5, wherein a through path is disposed in the sleeve, and the through path is configured to be passed through by a wire cable of the interface to enter the supporting portion; and
both the supporting portion and the casing have a hole at a corresponding position, and the hole is configured to be passed through by the wire cable to enter the casing, so as to establish a connection with the circuit board inside the casing.

7. The wireless modem according to claim 5, further comprising a grounding resilient plate disposed inside the supporting portion, and the grounding resilient plate contacts the first rotating shaft assembly and the second rotating shaft assembly respectively.

8. The wireless modem according to claim 1, wherein the second rotating shaft assembly comprises a rotating shaft covering, and a first cam, a second cam, and an elastic member in the rotating shaft covering;
wherein two ends of the first cam are a fixed end and a connection rod respectively, the fixed end being disposed outside the rotating shaft covering, and the second cam and the elastic member being sleeved on the connection rod; and
wherein the supporting portion is connected to the rotating shaft covering and the casing is connected to the fixed end.

9. The wireless modem according to claim 8, wherein the elastic member comprises a resilient plate.

10. The wireless modem according to claim 1, wherein the interface is a Universal Serial Bus (USB) interface.

11. The wireless modem according to claim 3, wherein the bump is disposed on the spacing gasket and the concave point is disposed on the corresponding position of the movable bracket.

12. The wireless modem according to claim 3, wherein the concave point is disposed on the spacing gasket and the bump is disposed on the corresponding position of the movable bracket.

13. The wireless modem according to claim 5, wherein the fixed bracket is fixed on the sleeve through the other end surface of the sleeve.

14. The wireless modem according to claim 5, wherein the first rotating shaft assembly further comprises a locking gasket and the locking gasket is sleeved on the sleeve and is located between the end surface on the other side of the sleeve and the fixed bracket, and the locking gasket is configured to fix the fixed bracket on the sleeve.

15. The wireless modem according to claim 1, wherein the first rotating shaft assembly is electrically connected to a metal shield layer inside the interface, and the second rotating shaft assembly is electrically connected to the circuit board inside the casing.

16. The wireless modem according to claim 7, wherein the grounding resilient plate is configured to ground the circuit board inside the casing.

17. The wireless modem according to claim 8, wherein the elastic member comprises a spring.

18. The wireless modem according to claim 1, wherein the interface is a Wireless Fidelity (WIFI) interface.
